(19) United States
(12) Patent Application Publication
(10) Pub. No.: US 2007/0174630 A1
(43) Pub. Date: Jul. 26, 2007

(54) System and Method of Mobile Anti-Pharming and Improving Two Factor Usage

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 11/307,732

(22) Filed: Feb. 18, 2006

Related U.S. Application Data
(60) Provisional application No. 60/593,877, filed on Feb. 21, 2005.
(60) Provisional application No. 60/593,879, filed on Feb. 22, 2005.
(60) Provisional application No. 60/594,043, filed on Mar. 7, 2005.

(51) Int. Cl. H04L 9/32; G06K 9/00; G06Q 99/00; H04K 1/00; H04L 9/00; G06F 17/30; G06F 15/16; G06F 7/04; G06F 7/58; G06K 19/00

(52) U.S. Cl. 713/183; 713/181; 713/184; 726/5; 726/6; 726/7; 705/64; 705/70; 705/72

(57) ABSTRACT

A variant of phishing involves subverting an Internet access point, often used for mobile computing. Malware can route user requests for bank websites into a phisher's private network, with fake bank websites (pharming). The user can have a “mobile password” at the bank. When she connects from an access point, she sends a hash, found from the password, starting at some position in it. The bank returns a hash, found from the same password, starting at another position in it. Each can verify the other. We protect both from a man in the middle attack. By hashing a web page and the mobile password, and inserting the hash into the page that is sent, the recipient can verify that the page is untampered. We use an anonymizer, external to the access point. A user pre-establishes a password with the anonymizer. At the access point, she and the anonymizer use a zero knowledge protocol to verify each other, based on the password. Then, the password encrypts communication between them. From the anonymizer, she logins elsewhere. The anonymizer is our man in the middle, to defeat a man in the middle attack. W extend earlier antiphishing methods, to attack pharms for non-existent banks, or that are unauthorized websites for actual companies. We show how to use a plug-in to let websites share several two factor implementations. This reduces the cost and inconvenience to consumers, who might otherwise have to carry and use a different two factor gadget, for each of their bank accounts or other corporate websites that mandates the usage of two factor authentication. By expanding the scope of two factor usage, we improve the security of e-commerce, without having to use a public key infrastructure.

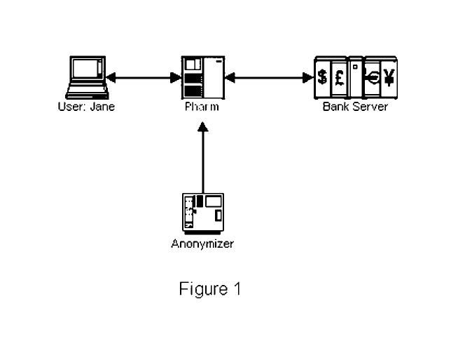

### CROSS-REFERENCES TO RELATED APPLICATIONS

This application claims the benefit of the filing date of U.S. Provisional Application, No. 60/593,877, “System and Method for Improving Two Factor Usage”, filed Feb. 21, 2005, and which is incorporated by reference in its entirety. It also incorporates by reference in its entirety the U.S. Provisional Application, No. 60/593,879, “System and Method of Mobile Anti-Pharming”, filed on Feb. 22, 2005, and the U.S. Provisional Application, No. 60/594,043, “System and Method for Upgrading an Anonymizer for Mobile Anti-Pharming”, filed on Mar. 7, 2005.

### REFERENCES CITED

antiphishing.org.

“Understanding PKI: Concepts, Standards and Deployment Considerations” by Adams and Lloyd, Addison-Wesley 2002.

“SSL and TLS: Designing and Building Secure Systems” by Rescorla, Addison-Wesley 2000.

http://www.schneier.com/blog/archives/2005/03/the_failure_of.html

“Applied Cryptography” by Schneier, Wiley 1995.

“Practical Cryptography” by Ferguson and Schneier, Wiley 2003.

“Javascript: the Definitive Guide” by Flanagan, O'Reilly 2001.

“WiFi Security” by Curran, BookSurge 2004.

“WiFi Security” by Miller, McGraw-Hill 2003.

### TECHNICAL FIELD

This invention relates generally to information delivery and management in a computer network. More particularly, the invention relates to techniques for protecting users against phishing and pharming, especially in mobile computing.

### BACKGROUND OF THE INVENTION

The scourge of phishing has increased greatly in recent years, some 7000% from 2002 to 2004. (Cf. antiphishing.org and references therein.) This has typically involved phishers sending bulk email purporting to be from a financial institution, like a bank. The email usually has several valid links to the actual bank. But the email might have a form in which the user is asked to fill in personal information, and a button that uploads this to the phisher, and not to the bank. Or, the email might have a link to a phisher's website. This website is called a pharm. The user is induced to click on the link, where typically she is reading her email in a browser or other computer program that can display and follow HTML links. The pharm often looks like the actual bank. The phisher can do this by spidering the bank's public web pages, and copying them to her pharm, to build verisimilitude. Of course, the visitor to the pharm is encouraged to fill out her information and upload it to the pharm.

There are variants on this, where the visitors to the pharm are brought by manipulating search engine rankings, rather than by using email.

Thus far, the above discusses the main modes of phishing. But recently, there has been a separate and independent technological and social trend. Mobile computers have gotten more popular and powerful. Like laptops and PDAs, for example. Let Jane be a user with a laptop. She might take it with her to a local coffeeshop with a hot spot. The latter is a gadget that offers wireless connectivity to the Internet. In the developed countries, hot spots are proliferating in the cities, as more people want to connect to the Internet in this manner. Some Internet cafes might also let customers bring in their own computers and connect these, in a wired or wireless fashion, to the Internet.

The popularity of increased mobility makes such hot spots and cafes attractive targets for another variant of phishing. Let Amy be a phisher. And suppose Jane has an account at bank0.com. Also, suppose that bank0.com's IP address is 2.3.4.5. Amy might replace the gadget that provides Internet access with her own device. Or if the gadget's software is vulnerable to her, she might replace it with her own software. In either case, her software acts as a malware custom router. It might simply record all the traffic going through it. So it acts as a sniffer. But sniffers are a known problem, and the use of https (and similar protocols) to encrypt sensitive transmissions is usually adequate to defeat them.

More perniciously, Amy's software might check for a user wanting access to bank0.com, for example. Prior to installing her software, she might have built a small, parallel Internet. Where she takes several websites on the real Internet, like bank0.com, and copies their public content to her Internet, which is just a private network that uses the Internet Protocol. In her Internet, she maps bank0.com to an IP address of 2.3.4.5, which is the bank's actual address on the real Internet. Her network might be emulated on one machine. In general, she does not need to have a different machine for each website that she is faking. Specifically, her network might be contained within the software that she has installed at the hot spot or cafe. Or, the software might communicate with an external machine of hers, that maintains the fake websites, perhaps using a VPN.

Then, when the software sees a user trying to connect to one of the websites that it is faking, it routes the connection to the fake website. On each of the latter, Amy has a web server waiting to answer queries, and capture Jane's username, password and any other personal details Jane might be fooled into revealing.

This is far different from running a simple sniffer. Here, the use by Jane of https when attempting to login to bank0.com is no protection. The web server sitting at the fake bank0.com gets her data in plaintext, after it unwraps the https encoding. Likewise for other channel encryption modes, like sftp.

Jane faces a difficult problem—ascertaining if bank0.com is real or fake. Also, this method bypasses the methods of our earlier Antiphishing Provisionals (see below), which assumed that real websites and pharms are on the same Internet. Then, the use of Partner Lists and tags is extremely powerful in attacking phishing. Which suggests another possible trend. If by various means, including our methods, the bulk of standard phishing and pharming are successfully detected, then it gives extra incentive for phishers to go to this mode of pharming.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

A dangerous variant of phishing involves subverting an Internet access point, often used for mobile computing. Malware can route user requests for bank websites into a phisher's private network, with fake bank websites. The user can have a “mobile password” at the bank. When she connects from an access point, she sends a hash, found from the password, starting at some position in it. The bank returns a hash, found from the same password, starting at another position in it. Each can verify the other. We protect both from a man in the middle attack. By hashing a web page and the mobile password, and inserting the hash into the page that is sent, the recipient can verify that the page is untampered.

We use an anonymizer, external to the access point. A user pre-establishes a password with the anonymizer. At the access point, she and the anonymizer use a zero knowledge protocol to verify each other, based on the password. Then, the password encrypts communication between them. From the anonymizer, she logins elsewhere. The anonymizer is our man in the middle, to defeat a man in the middle attack.

We extend earlier antiphishing methods, to attack pharms for non-existent banks, or that are unauthorized websites for actual companies.

We show how to use a plug-in to let websites share several two factor implementations. This reduces the cost and inconvenience to consumers, who might otherwise have to carry and use a different two factor gadget, for each of their bank accounts or other corporate websites that mandates the usage of two factor authentication. By expanding the scope of two factor usage, we improve the security of e-commerce, without having to use a public key infrastructure.

### BRIEF DESCRIPTION OF THE DRAWINGS

There is one drawing. It shows a user connected to a pharm which in turn is connected to a bank's website. The pharm is a man in the middle. The drawing also shows the pharm connected to an anonymizer which is connected to the bank.

### DETAILED DESCRIPTION OF THE PREFERRED EMBODIMENT

What we claim as new and desire to secure by letters patent is set forth in the following claims.

We described a lightweight means of detecting phishing in electronic messages, or detecting fraudulent web sites in these earlier U.S. Provisionals: Number 60522245 (“2245”), “System and Method to Detect Phishing and Verify Electronic Advertising”, filed Sep. 7, 2004; Number 60522458 (“2458”), “System and Method for Enhanced Detection of Phishing”, filed Oct. 4, 2004; Number 60552528 (“2528”), “System and Method for Finding Message Bodies in Web-Displayed Messaging”, filed Oct. 11, 2004; Number 60552640 (“2640”), “System and Method for Investigating Phishing Websites”, filed Oct. 22, 2004; Number 60552644 (“2644”), “System and Method for Detecting Phishing Messages in Sparse Data Communications”, filed Oct. 24, 2004; Number 60593114, “System and Method of Blocking Pornographic Websites and Content”, filed Dec. 12, 2004; Number 60593115, “System and Method for Attacking Malware in Electronic Messages”, filed Dec. 12, 2004; Number 60593186, “System and Method for Making a Validated Search Engine”, filed Dec. 18, 2004.

We will refer to these collectively as the “Antiphishing Provisionals”.

Below, we will also refer to the following U.S. Provisionals submitted by us, where these concern primarily antispam methods: Number 60320046 (“0046”), “System and Method for the Classification of Electronic Communications”, filed Mar. 24, 2003; Number 60481745 (“1745”), “System and Method for the Algorithmic Categorization and Grouping of Electronic Communications, filed Dec. 5, 2003; Number 60481789, “System and Method for the Algorithmic Disposition of Electronic Communications”, filed Dec. 14, 2003; Number 60481899, “Systems and Method for Advanced Statistical Categorization of Electronic Communications”, filed Jan. 15, 2004; Number 60521014 (“1014”), “Systems and Method for the Correlations of Electronic Communications”, filed Feb. 5, 2004; Number 60521174 (“1174”), “System and Method for Finding and Using Styles in Electronic Communications”, filed Mar. 3, 2004; Number 60521622 (“11622”), “System and Method for Using a Domain Cloaking to Correlate the Various Domains Related to Electronic Messages”, filed Jun. 7, 2004; Number 60521698 (“11698”), “System and Method Relating to Dynamically Constructed Addresses in Electronic Messages”, filed Jun. 20, 2004; Number 60521942 (“1942”), “System and Method to Categorize Electronic Messages by Graphical Analysis”, filed Jul. 23, 2004; Number 60522113 (“2113”), “System and Method to Detect Spammer Probe Accounts”, filed Aug. 17, 2004; Number 60522244 (“2244”), “System and Method to Rank Electronic Messages”, filed Sep. 7, 2004.

We will refer to these collectively as the “Antispam Provisionals”.

To combat the above, our method is a straightforward extension of “0046”, where we discussed how two parties can verify that they possess the same canonical data, without actually sharing the data. Consider Jane when her laptop is connected to the Internet at her home or office. Under most circumstances, it is a reasonable assumption that the ISP providing this does not have phishing malware running on it. Since the ISP's main business is to provide Internet connectivity, it has every incentive to do so. To this ends, an ISP has sysadmins and intrusion detection systems watching for malware.

Note the contrast with a hot spot. There, it is typically in an environment like a coffeehouse, which primary business is not Internet connectivity. Thus the employees may often lack the technical background to guard against Amy swapping in her gadget. Plus, such businesses rarely run security checks on their employees. So Amy might take a job there, in order to install her software. Even in Internet cafes, whose business is Internet connectivity, the remarks here may often hold true.

In passing, we should add that if phishers migrate towards such tactics, it may be an improvement over the current state, from an antiphishing viewpoint. Because for a phisher to target individual hotspots or cafes is very labor intensive. And each such location would only have a limited number of customers. Plus, physical access to the targets is riskier to the phisher. As contrasted to current phishing methods of sending out millions of mailings, and where a phisher might be in a different country from her targets.

So when Jane's laptop is connected at her home or office, she can go to bank0.com and define one or more “mobile passwords”. Or she can ask the bank to generate these for her. Bank0 stores these passwords in its database, for her, and she stores them on her laptop. Optionally, instead of the latter, she might commit them to memory. A mobile password is just a password that she will use when connecting from a location of uncertain provenance, in the following manner.

Let Alpha be a mobile password, for Jane at bank0. Let f(Alpha, i) be a hash made from Alpha, starting at bit position i. The hashing method can be any widely supported hashing method, and one that bank0 commits to using. Optionally, but preferably, the input to the hashing is the bits in Alpha, starting at i, going to the end, and circling around, as in a ring buffer. This has the merit that if i points to somewhere near the end of Alpha, the hashing still has many bits to operate on. It is also for this reason that i counts a bit position, as opposed to a character position. A typical password might be under 10 characters in length. If we were to use i as a character position, we could only make 8 or 16 times less in terms of output hashes. (Depending on whether a character is held in 8 bits or 16 bits.)

Jane uses her laptop's browser to go to bank0.com. But is the latter real or fake? At the login page, typically she has to provide her username and password. But this page might have extra input boxes, where her browser or a plugin can enter three quantities, f(Alpha, i), i and j. Assume without loss of generality, that a plugin does this. It can randomly generate i and j, where j also refers to a bit position in Alpha, and we have the restriction that i!=j. The plug-in finds f(Alpha, i) and writes the quantities to the web page. Or these might be entered at a special login page, for mobile access. The real bank0 knows Alpha. So given i, it can find f(Alpha, i) and compare it with what Jane submitted. This acts to verify Jane to the bank.

But the bank is now required to compute f(Alpha, j) and write this in a web page, or possibly send it back to a Web Service running on Jane's laptop. The fake website does not know Alpha, and since hashing is a one way function, it cannot find Alpha from f(Alpha, i). Hence, it cannot return a correct f(Alpha, j).

On the page where f(Alpha, i), i and j are entered, the bank might have special tags, to indicate which input widgets these correspond to. The plug-in might have knowledge of these, and use them to decide where to insert the data.

A variant on the above is for Jane to transmit f(Alpha, i) and i. The bank chooses a j!=i and returns f(Alpha,j) and j.

A variant is that in tandem with both sides knowing Alpha, both might also use a common salt, where this is combined in some fashion with Alpha prior to finding a hash.

Or, bank0 might have a Web Service, or Application Programming Interface, where the quantities can be transmitted to, from Jane's machine.

There is no need here for a heavyweight Public Key Infrastructure. The hashing is computationally far less effort. Plus, in some countries, usage of PKI might be regulated or restricted. Whereas the pharming scheme described here has global scope. Likewise, our method against it also has global scope.

Optionally, instead of Jane using a mobile password at bank0, it might say that it and she should use her regular password, in order to find hashes.

A variant on the above is that Jane and her bank define two mobile passwords. Then, from an insecure connection, she sends the hash of one password, and expects the bank to return the hash of the other password.

Two Factor

Some banks provide, or require, that customers using remote access also use a two factor gadget. It is often a separate device, though in principle a two factor method could also be implemented in software on a customer's computer. There are scaling problems with Jane having several such gadgets, one for each bank at which she has an account. But aside from these, two factor methods are most often, if not entirely used, by a bank to verify its customer, and not for a customer to verify the bank.

We propose an extension of the two factor method. Currently, such a device has a stable clock, with little drift. So that it makes a one time password, which is a function of the time, and possibly other parameters. This is transmitted to the bank, which also calculates the password,

and compares the two. Now, both sides make two one time passwords, as functions of the time, in some common deterministic manner. Jane sends one to bank0, by typing it into some widget on a web page. If it verifies, then bank0 displays the other password, so that Jane can verify that.

Alternatively, while a one time password might be valid for an hour, or a few minutes, it might be desired not to transmit even that. So Jane's gadget might find a hash of the password, starting at some random bit position, and send the hash and the bit position to the bank, along with another bit position. And the bank can then return a hash made starting from the latter position.

Also, we propose a mode where a two factor gadget can receive a password and compare it against an internally generated password. This is especially pertinent if this receiving of the password is via a communications channel different from that used by Jane to contact the Internet.

Extensions

In the above, we discussed IPv4. Our analysis holds true with IPv6.

We chose the example of a bank. Actually, any company or organization with a website and users who have to login is vulnerable to the pharming scheme, and can use our method against it.

We described hot spots and Internet cafes as potentially dangerous sites. In general, other types of Internet access points might also qualify. Our method lets the user decide at which she wants to use it, for greater safety.

We discussed how to generate several hashes from a password, starting at a bit position within it. Hashing was chosen because the theory of hashing is very well understood, and there are several hashing algorithms in common usage. More generally, any zero knowledge method involving a password known to the user and bank can be used by them to verify each other.

Plus, if hashing is used, more elaborate schemes other than hashing the common password, starting at a bit position within it, can be applied. We cited that example as a simple implementation.

We gave the example of a human, Jane, who wants to verify a website. Our method can also be used by a fully automated mobile computer, that has intermittent access to the Internet, using connections of unknown veracity.

When Jane is connected at her office or home, the plug-in might choose a random set of IP addresses, and do a traceroute to them, and record the results. Then, when her computer is at a mobile location, the plug-in might occasionally traceroute to those addresses, and compare the resultant paths and times to those it had earlier recorded. Significant discrepancies might suggest an invalid Internet connection.

Man in the Middle Attack

Amy might also attempt a man in the middle attack. In the pocket universe of her private Internet, she pretends to be bank0 to Jane. While she also simultaneously connects to the real bank0 in the real Internet, pretending to be Jane. Amy takes the inputs from Jane, records them, and forwards them to bank0, in order to login as Jane. And Amy takes the replies from bank0 and forwards them to Jane.

We emphasize again that https, or other equivalent channel encryption methods, offers no useful protection against this attack. But currently, the vast majority of e-commerce restricts itself to using https. Most crucially, these websites have the user send her username and password in what is equivalent to plaintext, since Amy can unwrap the https.

In general, such an attack is very difficult to defeat. Some cryptography experts suggest that the only fundamental solution uses quantum cryptography. We present here two methods that can mitigate several aspects of the attack, without recourse to quantum mechanics.

Firstly, Jane and bank0 both know a common password, Alpha. This can be used as a key to a cryptosystem implemented by the plug-in and the bank. (There is no need for a PKI.) So the messages that Amy gets from either party are encrypted, and she does not possess the key. But this common cryptosystem might be complex enough that it may face regulatory restrictions on its possession, usage or export in various countries. Plus, for bank0's server to encrypt each outgoing web page, and decrypt each incoming message from Jane may scale badly with the number of users logged into it. So while a full encryption and decryption approach might defeat the man in the middle attack, it comes at a heavy computational price.

Secondly, Jane can login using our methods described above, which do not involve transmitting Alpha. Now consider a web page sent by bank0 to Jane, after she has logged in. Bank0 can treat this page as a string or bit array, and combine it with Alpha and hash the total resultant bit array. This hash might then be inserted into the page, as a custom tag like, for example:

<notpharm hash=“d0ea839 . . . ”/>

The combining of the web page and Alpha in order to find a hash, can be done in any arbitrary deterministic fashion. A simple choice is just to append Alpha to the web page bit array, before hashing. Then, take the computed hash, insert it into the above tag, put the tag in the page, and send the page to Amy, who is pretending to be Jane. Amy then presumably forwards it to Jane. Jane's plug-in removes the hash tag, and independently finds the hash of the combination of the web page and Alpha, and compares this computed hash to that sent from bank0. If the two agree, then the page was not altered in transit. Since Amy does not know Alpha, any changes she might make to the page can be detected by Jane. This protects Jane against any misleading information that Amy might present to her, as supposedly coming from bank0.

Now consider the transmission of information from Jane to bank0, after Jane has logged in. Typically, bank0 will make a web page that also has links to other pages with other data about Jane. One danger is that Amy might disconnect Jane, and then visit the links in that page, to extract more data on Jane. To combat this, assume Amy does not disconnect Jane. The page that Jane gets from bank0 can be simply changed by her plug-in, which modifies the links in it, before telling her browser to display the page. Consider a typical link, <a href=“https://a.bank0.com/bin/d0”>. The plug-in replaces this with a scripting subroutine, so that if Jane clicks the link, the subroutine is called. In pseudocode, the subroutine does the following:

subroutine addHash (String url)
{
String s = url + Alpha;
String hash = makeHash (s);
append hash to url;
tell the browser to go to url;
}

In the above, the input argument url is the original value of href. And makeHash( ) is whatever hashing algorithm is used by both the plug-in and bank0. We also chose to combine the url and Alpha in the manner (url+Alpha). Obviously, this is arbitrary, and some other choice of combination would be equally valid, so long as both the plug-in and bank0 implement that choice. Also, in the appending of the hash to the url, this would be done in the standard manner of writing arguments to any URL—for example the appending might be written as “&hash=083de . . . ”.

Hence, if Jane were to click on a link that points to bank0, the latter's web server will expect to see not the original URL, but one with a hash. The server removes the appended hash, and then computes the hash of (url+Alpha) and compares the two hashes. If they are equal, then Jane clicked on the link. But if the hashes are different, or if there is no hash in the URL, then server will not display the page.

This prevents Amy from viewing Jane's pages that Jane has not explicitly clicked on.

A variant on the above is if Bank0 were to use a dynamically constructed link, instead of a static link. Here, the former would be done by a scripting routine in the page. One answer is that Bank0 should not be encouraged to do this. It is a technique that can be used by phishers to obfuscate their links, to avoid their messages being easily detected by an ISP applying a blacklist against links in the body of a message (“1698”). If Bank0 uses such dynamic links, it runs the risk that its messages might be inadvertently considered as spam, and possibly blocked from reaching their recipients. However, if Bank0 were indeed to use a subroutine to make a dynamic link, it might have an extra argument. The plug-in could then hash the (subroutine+Alpha), and then change the link so that it calls the subroutine, with the hash written into that argument's position. Presumably, the subroutine would construct a link, and append the hash argument in some manner such that the bank can extract it when the link is received by the bank's server.

In the above, Alpha must be long enough that it is computationally infeasible for Amy to deduce it, by essentially repeatedly computing the makeHash subroutine, with a known URL, and varying the choices of Alpha, until the resultant hash is the same as that written in the observed URL. We suggest that Alpha be at least 120 bits long.

An important extension of this method handles forms present in a page sent to Jane, where such forms have a submit button. Pressing this button causes the form's values to be sent to the server. It is crucial to prevent Amy filling out false values. Imagine, for example, a form that lets Jane withdraw money, by typing an amount, and giving the routing number of another bank, and an account number at that bank. If Jane were to fill it out and submit it, there would be value to Amy to being able to change the amount and routing and account numbers, to divert funds to Amy.

As above, when the plug-in gets the page with a form, it can replace the link in the submit button with a subroutine call. In that subroutine, it finds the values defined by Jane in the form, combines these into a bit array and appends Alpha to it. The resultant bit array is hashed. Then the form's values and hash are sent to the bank, by either an HTML GET or POST. The bank removes the hash, combines the form's values into a bit array, combines Alpha with it and makes a hash. It compares the two hashes. If they are equal, then Jane sent the message. Else, the message has been altered in transit and the operation is not carried out.

A variant on the above form submission is for the plug-in's subroutine to find the current time, express it in Universal Time and write this as a string, in some standard format, like YYYYMMDDHHMMSS, where, for example YYYY means use 4 characters for the year. Then, the bit array of values in the form and this string and Alpha are appended and hashed. Then the form's values and hash, and the time are sent to the bank. This helps reduce the chance of a replay attack when Amy records Jane's message and tries to submit it at some later time. (Here, the order in which the form values, the time and Alpha are appended is immaterial, except of course that both the plug-in and the bank must perform the same order.)

Another variant also aims at preventing a replay. Here, instead of the plug-in's subroutine using the current time, the subroutine uses what we term a “submit counter”. An integer variable that is incremented after every use, and written to disk, so that it monotonically increases, even across different power-ups of the computer, and different instantiations of the browser. This counter value is included in the input to the hash, and is also sent to the bank. For Jane, the bank only needs to keep a record of the last value used. Any valid future values should/must be larger.

Here, the plug-in could maintain a different submit counter for each “special” website that Jane designates. For example, for every bank that she has an account at. Or, it might just maintain one such counter, across all these usages.

A minor caveat is when or if the counter reaches the largest positive value that it can represent. One possibility is that it can reset to 0. While the bank might have corresponding logic to detect if the counter is approaching a maximum, and then to permit a valid future value of 0 or some small positive integer.

Optionally, this usage of a time or counter might also be done when modifying the links, with the value being written into the changed links.

The common idea here in the transmission from Jane to the bank, or vice versa, is in adding a password to a message, hashing it, and adding the hash to the message. Because this method uses authentication instead of a strong encryption/decryption, it should not face any regulatory constraints, and thus it should be able to be deployed globally.

These methods of minimizing a man in the middle attack can also be used in other circumstances. Suppose Amy successfully launches a malware attack against a domain name server that serves some portion of the Internet, such that queries from the latter portion to bank0.com get directed to her server. Then, her server relays such queries to the real bank0.com domain. Clearly, our above methods can also be used here, to reduce the effect of such an attack.

Bank0 does not need to have all its customers use our plug-in and methods, when they are at mobile locations. (Though it could require this.) In the above scenario, Jane initialized her Alpha password when connected to bank0 at a reliable location. This also told bank0 that Jane has our plug-in, and that perhaps as an explicit request from her, that she wants all her mobile transactions to be via the methods discussed here.

The above ideas can also be applied when both Jane and bank0 are entirely computer programs, interacting possibly via some Web Services manner. Messages can have hashes appended that are functions of the messages and of a known common password.

We have described two main methods. One involves encryption of all traffic between Jane and Bank0. The other does not, beyond any https. A given implementation might combine both methods. So that, say, most web pages going from Bank0 to Jane, and her responses to those, are unencrypted, and use the hashes for protection. But some, possibly very sensitive pages, might be fully encrypted, along with Jane's responses to those pages.

Using an Anonymizer

But what if Bank0 has not yet implemented the procedure described above? Or will not, for whatever reason? In this event, Jane does not have that mobile password, Alpha, established at Bank0. How can she protect herself at a hot spot, if she needs to login to her Bank0 account?

We show here how she can still defend herself.

It involves Jane connecting to an anonymizer, via which she can then connect to the real Bank0.com. Typically, current anonymizers let a user protect her privacy, often specifically her network address, when she visits a website. Let A1 be an anonymizer. She would use her browser to got to A1.com. There, it often has a box (text widget) in which she can type the URL of some other website, say W.com. Then A1 will go to W.com, get the web page, and then relay it to Jane's computer. So W.com never sees Jane's IP address. A1 may or may not require Jane to log in to it first, before it goes to any other website. Often, an anonymizer will let anyone surf the web, if she uses http. But if she needs to use https, the anonymizer will often require that she log in to it first. Usually this implies that she has to sign up as a paying customer. The business model of most anonymizers.

In our method, when Jane is at a reliable Internet connection, she connects to A1, and defines or gets a password, Alpha. So Alpha is stored on her machine and in A1's database for Jane.

Now, when Jane is at a hot spot, she can connect to A1.com, using the method earlier in this Invention. Both she and A1 use a zero knowledge protocol based on common knowledge of Alpha, to establish each other's authenticity. Optionally, but preferably, this protocol can be fully automated, with Jane perhaps only needing to be manually notified if her machine is unable to verify A1. (Optionally, this zero knowledge protocol can be that defined above.)

This combats Amy setting up a fake A1.com website inside her pocket universe. Now it is still possible that after Jane and A1.com have verified each other, that the actual network connectivity is Jane <---> fake A1<---> A1. Here, the fake A1 has relayed, unchanged, the messages between Jane and A1, when they were performing their zero knowledge protocol. The fake A1 cannot change anything in the relayed messages without one or both of Jane and the real A1 detecting this.

Of course, how would Amy know to set up a fake A1.com, given that in general she does not know a priori that Jane is going to use the hot spot, and that she does not know that Jane would use that particular anonymizer? Remember that Jane represents a typical user. Amy can make a reasonable guess at what are the most common anonymizers that use our method, and then implement fake websites for some subset of those. So that if Jane were to want to go to anonymizer A15.com, and Amy does not have a fake website for it, then Amy's software can merely route Jane's request to the real A15.com. It is important from Amy's standpoint that her software does this, instead of, say, blocking the request. This latter step might alert Jane that something is amiss with the hot spot, and she might alert others, non-electronically, about it.

Now that Jane and A1 have verified each other, they need to both implement a common cryptosystem, based on the key Alpha, to send encrypted messages between each other. So that the fake A1 does not get plaintext. This differs from earlier in this Invention, where Jane and the other real party could send each other plaintext messages. There, a message would have embedded codes that the recipient could use to verify that the message came unaltered from the sender. These codes were a function of the rest of the message and of the common key. But here, the reason that Jane goes out to A1 is merely as a secure means to get to Bank0.com. She needs to pass her username and password for her Bank0 account to Bank0.com. Hence, her communications with A1 need to be encrypted.

It is important to note that after Jane and A1 have verified each other, the subsequent encryption cannot be the standard https. Because the fake A1 that sits between them can unwrap such an encrypted message, record it, and then https it to its destination.

However, a particular implementation might be a variant of the standard https, where each side uses Alpha as the key, without of course ever passing it to the other. This modification of https has the advantage that it is relatively easy to code, given that only the obtaining of the key changes. And the usage of https beyond this is the same as standard https. Hence the computational burden of this cryptosystem is fairly lightweight, compared to a full PKI, for example.

We assume that A1 has secure connections to the Internet, and can reach Bank0.com and other destinations, without going through a hot spot of unknown provenance.

The above extension of a standard anonymizer can be considered a premium service. Especially since it involves more of a computational load on the anonymizer, compared to its existing services. It can enhance the business role of an anonymizer.

Jane could have passwords at several anonymizers that use our method. Perhaps since some might be temporarily unavailable when she is at a hot spot.

In the above, we referred to a hot spot. Perhaps a wireless environment. Our remarks also apply when Jane goes to a wired environment, into which she plugs her mobile computer. It also applies, though with caveats, if Jane does not have a mobile computer and goes to some other machine. That machine may have a browser or plug-in that implements, or claims to implement, our method. The danger is that since this method assumes that the Internet connectivity at the hot spot may be compromised, then so too might any machines at that location that are available for a user.

On Jane's machine, we have a plug-in to her browser, that implements our method. Or the method might be incorporated by default into the browser itself.

Our method might also be implemented in any programs on her machine that can show documents with hyperlinks and which let her pick those hyperlinks and go to those destinations.

While we have used the example of a bank that a user might connect to, in general, any website at which a user is a member of can also be considered in the context of this method.

We have referred to a human user. But our method also applies to a hardware device that might be mobile, for example, and which needs to periodically consult websites on the Internet. The device might do this by occasionally coming into contact with devices with Internet connectivity. Just as for a human user, the device has a need to guard against man in the middle attacks.

Dynamic Links

Now suppose Bank0 were to use the method earlier in this Invention, with the mobile password, but it uses a dynamically constructed link, instead of a static link. Here, the former would be done by a scripting routine in the page. (Written in JavaScript or some other scripting language likely to be supported by most browsers.) Possibly Bank0 should not be encouraged to do this. It is a technique that can be used by phishers to obfuscate their links, to avoid their messages being easily detected by an ISP applying a blacklist against links in the body of a message. If Bank0 uses such dynamic links, it runs the risk that its messages might be inadvertently considered as spam, and possibly blocked from reaching their recipients. However, if Bank0 were indeed to use a subroutine to make a dynamic link, it might have an extra argument. The plug-in could then hash the (subroutine+Alpha), and then change the link so that it calls the subroutine, with the hash written into that argument's position. Presumably, the subroutine would construct a link, and append the hash argument in some manner such that the bank can extract it when the link is received by the bank's server.

Non-Existent Banks and Other Pharming Methods

A recent variant of phishing and pharming involves users receiving email directing them to a website (pharm) that claims to be a bank. However, unlike other pharming, where the website is fake, but claims to be a well-known bank, the new website represents a non-existent bank. In this sense, this type of website is doubly fake. Sometimes, the email with links to the website, or pages on the website, might claim that the user has won a prize. This is often money. So the user might be urged to enter the name of a bank where she has an actual account, and the number of that account. Possibly other personal information might be asked from her. The reason given might be that the (fake) bank can then remit funds to her real account.

Another strategy might be to tell her that to claim her prize, she must establish an account at the (fake) bank. Hence, she is invited to enter personal information. Which the phisher can then use to assume the user's identity.

A variant is to set up a fake website claiming to be some non-existent financial institution offering credit cards. And then inviting visitors to apply for those cards.

The gist of the above is for the phisher to cleverly avoid faking an actual bank. This lets her avoid many antiphishing methods.

Another phishing method is for a phisher to find a company (not necessarily in the financial sector) that does not have a website. Typically, this might be a company with only a few stores, and that might be more old fashioned, and has not gotten to establishing a website. Amy, the phisher, then sets up a website, purporting to be from that company. For verisimilitude, Amy might register the domain with the contact person having the real name of an executive of the company. Perhaps even giving the contact address as the company's actual address. She can do this because the physical location of the company can differ from the location of where its website is hosted. Then, Amy turns on the website. Often, she has chosen the company so that it sells products, for which she can easily drive customers to her website. This might be done via spam, or by using link farms to manipulate search engine rankings for those products, or even by buying ads at search engines. Customers arriving at her website might then hand over credit card numbers for purchases, which are never delivered. She runs the website for as long as she can, to harvest these funds.

Yet another phishing method involves Amy sending out phishing messages, claiming to be from a government agency. (Actual instances have included messages purporting to be from the US FDIC.) The messages might say that the recipient has to divulge some personal data, like her name and taxpayer identification number, in order to prevent some government action that will otherwise be taken against her.

We now describe extensions to our Antiphishing Provisionals to handle the above phishing and pharming attacks.

Consider a company, Phi, that is a client of an Aggregation Center (Agg). As explained in earlier Antiphishing Provisionals, Phi can submit its Partner Lists to the Agg, for dissemination. But Phi can also now tell the Agg several other data, including, but not limited to the following:

It has no Partner Lists.

It has no website.

It does not do mass mailings. (By this we mean unsolicited.)

It does not send any email.

It does not send any Instant Messages.

It does not send any SMS messages.

It does not send any messages in some other Electronic Communications Modality.

It has no Web Services.

A list of its valid phone numbers. (Which could be empty.)

Clearly, some of these settings would override others.

Most of the above refer to things that Phi does not have or does not do. The Agg can convey these to its plug-ins. Hence, the latter might be able to programmatically and objectively test for some or all of those items. A simple example is if Phi does not send mass mailings. Then, assuming that Phi has a domain, phi.com, if the plug-in parses a user's email and finds a Sender address someone@phi.com, then it can invalidate that message. This can be overridden if the user has that address in her whitelist.

Hence, a corporate or governmental customer of the Agg could use the above, in conjunction with the Agg, to prevent many types of phishing or pharming attacks, by phishers claiming to be it.

However, the first example in this section needs a different approach. Consider a national government that is a customer of the Agg. Every government regulates its financial sector. At the very least, we can expect the government to have a list of its licensed banks, and other financial entities, like brokerage houses. We consider this to be an “existential validation”. Note that this is not necessarily an affirmation of a bank's financial safety, beyond some minimal standard that the government might require. Typically, a financial rating of a bank or other type of company is given by a few specialized companies.

From the Agg's government customer, it can obtain such a list, and distribute it to its plug-ins, as well as to any ISPs that are its customers. At a plug-in or ISP, when analyzing a message, it could apply any subset of our AntiSpam Provisionals, and suitable extensions, or other antispam methods. Specifically, it might look for language dependent keywords, that pertain to the financial sector. In English, these might include “bank”, “account”, “credit union”, “credit card application”. Typically, there is also less leeway for a phisher to deliberately use visible mis-spellings, to avoid these searches. Here, such mis-spellings would tend to arose suspicions in the recipient, given the nature of the subject material. Thus, the plug-in could detect a website claiming to be a non-existent bank or other financial institution.

The government might furnish such data, and regularly update it, perhaps as a means of safeguarding its own financial sector and citizens, against phishers.

This process of existential validation could be carried several steps further by the Agg. For a given government customer, if that corresponding country has smaller regional governmental entities (“states” or “provinces” or “territories”), then the Agg might permit the national government to furnish a list of such entities. The national government validates these to the Agg. Recursively, such an entity might furnish the Agg with updated data about its own electronic policies, as discussed above. Plus it might furnish validated lists of affiliated companies or organizations in its region.

The Agg can analyze data from disparate sources. Including electronic messages received or emitted by ISPs, where these might be suitably anonymized using the hashing of “0046” to preserve the users' privacy. Other sources include uploads from its plug-ins, and the governmental sources mentioned above. By applying our Antispam Provisionals, including clustering, we can find associations and use these to rapidly offer assessments of phishing attacks.

Enhanced Two Factor Usage

We extend our earlier two factor discussion by showing how to incorporate multiple two factor authentication schemes into improving network security.

Two factor authentication [hereafter ‘two factor’ ] is a method that has been used for over ten years as a means of adding to the security of computer usage. Especially when the user remotely accesses that computer from a location outside the company's premises. It is usually implemented as a hardware gadget, typically about the size of a credit card. It has a display and perhaps a keypad and other buttons. When the user, Jane, wants to remotely access her computer, she is at another computer. She remotely logs into her computer and is asked to furnish her username and password, just as she would, if she had local access. But she is also asked to give a two factor password. She obtains this by pressing a button on her gadget. (She may also have to type some input into the gadget.) It generates a special password, which we designate as “alpha”. She then manually types this into the appropriate location in her remote access window and sends the information to the remote computer. If her information is validated, then she can log in.

Alpha is often time limited. That is, after a certain amount of time, it expires. The gadget has an internal clock, which is initially synchronized with the computer's clock. It also has some hardwired initial data that is specific to Jane. This is written into the gadget before Jane receives it. Then, whenever the gadget is asked for a password, it does some strong cryptographic function of the time and Jane's data, to make this password. The computer does the same thing, and compares its time sensitive password with that supplied by Jane from her gadget.

Several companies make such gadgets. While the technical details vary, the above description is a typical summary of the gist of operation.

It is also possible to implement two factor purely in software. So that Jane might load this into her laptop, say, and then run it to get the two factor password. This is not as common as a dedicated device. Possibly for several reasons. Firstly, having a gadget that is not connected to a network reduces the risk that it could be subverted. Secondly, if Jane does not have her laptop, then she cannot log in remotely. Whereas the gadget is smaller and easier to carry around. Without loss of generality, we will assume that two factor is implemented in a gadget, on the understanding that this also includes the pure software method.

In general, two factor methods are robust and secure against many types of attacks. They have mostly been used by employees of a company, which issues them with these gadgets. Usually those employees only work for one company at a time, so an employee only needs to carry around one gadget. However, with increasing electronic attacks, especially of the phishing variety, banks, brokerages, Internet Service Providers and other companies are considering or have implemented two factor. (“Banks Test ID Device for Online Security”, New York Times, 24 Dec. 2004.)

There is a fundamental problem of scaling. Unlike being an employee of only one company at a time, Jane might have several bank accounts, brokerage accounts and an email account at an ISP. It is very cumbersome for her to have and carry a gadget for each company that maintains a two factor policy. Each company that makes a two factor gadget might assert that the answer is that all vendors should use only that company's gadget. But, as a practical matter, for the foreseeable future, there will be several such companies.

Another problem is cost. As cited by the above New York Times article, a gadget might cost $10 and a monthly fee might also be imposed. A company could decide to reduce or waive these charges, but irrespective of this, the costs have to be borne by some combination of the company and the user.

We propose a method of extending the capability of the plug-in we have designed for antiphishing, so that companies and users can easily use two factor gadgets from other companies. In what follows, we describe the use of the plug-in inside a browser. Our method also holds when the plug-in is used inside any program that can show electronic messages and display and have functional any hypertext in those messages. We use financial companies as examples. But these can be generalized to any type of company.

Let Jane be a customer of Bank0, from which she has a two factor gadget. Assume that Bank0 is a validated client of the Aggregator. So that when Jane uses her browser to go to Bank0's website, the pages validate. (Or at least do not invalidate.) When she wants to login to her Bank0 account, she uses its gadget in the manner described above.

Now suppose she wants to login to Broker0. Assume that Broker0 is also a validated client of the Aggregator. Broker0 might issue its own gadget. Or, it can publish a list of other companies that issue gadgets. Call this a Two Factor List [TFL]. If Jane has a valid two factor password from one of those companies, Broker0 is willing to accept that, in lieu of its own. It is saying that it regards those companies as having sufficiently secure two factor implementations. This TFL is akin to the Partner List of “2245”. As with that list, Broker0 might promulgate this to the Aggregator. But the list can also appear in the login page for Broker0, for manual perusal by a human reader.

One difference between a TFL and the Partner List is that the TFL may have Broker0's competitors in it. In general, the Partner List will never have these.

Assume that Bank0 is in Broker0's TFL.

We now describe one preferred implementation of our method. Though others are possible.

Jane goes to the plug-in and brings up its menu. She picks an option, call it “get 2f”, say. This brings up a window where she can enter a network address for Bank0 (like a URL), and her username, password and her two factor password. For convenience, if she does this regularly, the plug-in might store the network address, username and password in some secure encrypted fashion on the local computer, and fill in those fields by default, whenever the window is brought up. Optionally, Jane would be able to instruct the plug-in to store these data or not.

She sends this information to Bank0, optionally but preferably via a secure communication method, like https. At that network address, Bank0 has a server which tries to validate her information. If it validates, then Bank0 returns certain information to the plug-in. At a minimum, it is a token, which is a pseudo-random bit sequence. Optionally, there might also be a timestamp, which is the time up to which the token will be regarded as valid by Bank0. The timestamp might be measured with respect to Bank0's clock or to some generally accessible time, like Universal Time. This reply is also optionally, but preferably, done via a secure communication method.

Given this information, the plug-in can display it in a window, and also hold it internally. There are now two possibilities. Firstly, in Broker0's login page, it might have a field where Jane can enter or choose Bank0, and another field for her to type in the token. She can copy and paste the latter from the plug-in window. If the information included a timestamp, there is no need for her to enter it anywhere. The timestamp is mostly for her visual perusal.

A second approach is more convenient for her, and less error prone. The login page might have custom tags, to designate which fields are for Bank0 and for the token. These tags are different from the markup tags that actually define the fields. For example, the field to pick or write “Bank0” might be delimited by <tfhost> and </tfhost>. While the field of the token might be delimited by <tftoken> and </tftoken>. Clearly, the names of the tags are arbitrary, and we choose these names merely as examples. Since a browser does not display unknown tags, these will not affect (degrade) the visual representation of the page. Jane can then bring up the plug-in's menu and pick another option, called “fill 2f”, say. This tells the plug-in to look at the page currently displayed, and write into the fields designated by the above tags. It is trivial for Broker0 to add the custom tags to enable this automatic filling.

In the above, we described how Jane takes two steps to execute the “get 2f”, and two steps for the “fill 2f”. A trivial variation is to have one or both of these options directly available on the browser as a button, or as a keyboard accelerator.

Jane now submits the login page to Broker0. Optionally but preferably via a secure communication method like https. Broker0 would take her username and password and try to verify these against its records. If these fail, then it returns an error message to her machine.

But suppose that data verifies. Now Broker0 takes the host field, and sees Bank0, which is in its TFL. So it takes the token and a code associated with Jane, and sends these directly to Bank0, who replies “yes” if the token is still valid (has not expired) and is associated with that code, in Bank0's records. It replies “no” if the token is invalid or if it is not associated with the code. Optionally, the “no” could be “no—token is unknown” or “no-token has expired” or “no—code is unknown” or “no—token is not associated with code”. Clearly, these quoted replies could and probably should be implemented as integers, for brevity, where the integers have the meanings given by the strings.

What is the purpose of the code? It is information associated with Jane, that is known to both Bank0 and Broker0. Suppose no code were used. Then suppose there is a phisher called Amy. She can, via a human proxy, open an account at Bank0, under the proxy's name. Amy can then obtain a token for that proxy, and use it when trying to impersonate Jane at Broker0. Where this assumes that Amy has, by various means, found Jane's username and password for Broker0.

So when Bank0 issued the token to Jane, upon her successful two factor login, it went to its data on Jane, and made the triple (token, timestamp, code) and returns to Jane either the single (token) or the double (token, timestamp). It is important to note that the code is never returned to Jane. When Jane then logs into Broker0, and assuming that her username and password for Broker0 are verified, then Broker0 takes the token and from its data on Jane, a code called code0, say. Then it sends (token, code0) to Bank0 for verification.

For both Bank0 and Broker0, the code that Jane gives them is usually done so when she opens her accounts with them. And perhaps on an occasional basis later, if this code changes. But for any normal login, for security reasons, neither Bank0 or Broker0 requires her to input the code.

The (token, code) method that is used for verification between the companies may be considered a two factor process, in its own right.

The code might be one of several types of data, mutually agreed upon by Bank0 and Broker0. Ideally, it should be globally unique. Since the companies might operate in several countries, and have customers of several nationalities. The code might be an email address, which satisfies the uniqueness. Or it could be an identification issued by a national government. Like a passport id, or a US Social Security Number, or an Australian Tax File Number. For such national data, to ensure global uniqueness, the formatting of the code when it goes from Broker0 to Bank0 should indicate the country of issuance. Any such formatting is arbitrary, but strictly as an example, we offer an XML formatting like this:

<code>
<co>us</co>
<i>123456789</i>
</code>

Here, the <co> and </co> tags delimit the country, where we use the Internet's two letter designation of a country. While the <i> and </i> tags delimit the main data.

The id might also be issued by a subregion of a country, like an American state, and could be, for example, a driver's license. In this case, the above XML example might have extra tags to designate the region.

Another optional feature is that Bank0 might place an upper limit on the number of times it will validate a token. This might be instead of, or, preferably, in addition to the expiration time. Hence, there might be another no answer—“no—token has been used too often”.

Note that the token gives Broker0 no information about Jane's username, password or even her two factor password for Bank0. This helps improve customer privacy. Especially because some usernames might be identifications issued by governments. While companies probably should not use these as usernames, as a practical matter, some do.

There are various extensions to the above process.

For example, a company might not offer any two factor gadgets. Rather it might require that this be done by the other companies on its TFL. This raises the issue of why a company in the latter would perform this for the former company. Perhaps because a company actually issuing gadgets and performing a two factor validation could charge another company for the validation requests it gets from that company.

In a related way, suppose Alpha and Beta issue such gadgets. Over a period of time, each can tally up the number of requests it gets from the other. Then by comparing these, the company with the greater number of requests it got might charge the other, based on the difference. (National phone companies often have similar peering arrangements with each other, in the context of international phone calls, for example.)

A TFL specific to a given company can be generalized in several ways. Including but not limited to the following. A group of companies could form a multilateral agreement that each will recognize a two factor done by any other company in the group. Or the group might agree that each will recognize a two factor done by any company in a second group. Where the second group might actually issue such gadgets, and the first group might not do so.

In such cases, the groups also make more efficient the agreement as to what type of code data is passed between members. In our above example of Bank0 and Broker0, we suggested that they come to some bilateral agreement on this. But groups can enable a simple multilateral agreement.

In our method, the preferred implementation is for the companies to be only those validated by the Aggregator/Trusted Search Engine. This improves the security of the method. However, the following cases are also possible. The companies who issue two factor gadgets might not be validated by the Aggregator. Independently of this, the companies who forward validation requests to a two factor issuer might not be validated by the Aggregator. The plug-in might be made capable of permitting such instances.

Also, consider a two factor issuer that is validated by the Aggregator. Independently of a plug-in's policy, the issuer can decide whether to answer validation requests from companies that are not validated by the Aggregator.

Another extension is that the plug-in itself might furnish a two factor password. The physical two factor gadgets are often handed out by a vendor to users after they have validated themselves in some fashion defined by the vendor. Likewise, consider when Jane is using her plug-in for the first time, and registers with the Aggregator. It might offer a premium service, where if she performs extra steps in the validation of her identity, then it might permit her plug-in to be able to issue her with two factor passwords.

A plug-in might do so for several users who have regular access to the computer on which the browser and plug-in run. If so, the plug-in can have some password requirement for each user.

Our method is an infrastructure process that lets companies with different two factor methods co-exist and compete. It also lets other companies use two factor methods, without requiring their customers to purchase and use such a gadget for each company. It is lightweight, in avoiding the issues of key management. By expanding the scope of two factor usage, our method improves the security of e-commerce.

Our method can also be used in the absence of any two factor implementations. For credential validation. Suppose Jane is a customer of Bank10, which does not use two factor. It might issue a credential, consisting of a token and an optional timestamp. Jane could get this by having her plug-in bring up a window in which she enters Bank10's address, her username and password. Then, by submitting this to Bank10, if it validates, then Bank10 replies with the credential.

Jane can use this in other websites, to prove that she is a customer of Bank10, by a trivial modification of the earlier process. It may be useful for another company to be able to validate this. So that, for example, it might customize an offer to her. Note that this does not use the code that we discussed earlier. That code arose in the context of Jane being an existing customer of two companies. In the current case, Jane need not be a customer of another website, so it would not have the code to pass to Bank10.

Optionally but preferably, this could be restricted to only those companies validated by the Aggregator.

What is claimed is:

1. A method of a user and a website (“bank”), of which she is a member, establishing a password (“mobile password”) to be used when she connects to it from an access point; where she hashes the password, starting at some bit position (“i”) in it, and sends the (hash, i) along with related data like her username to the bank.

2. A method of using claim 1, where if the information is verified by the bank, it replies with (hash, j), where this hash is made from the mobile password, starting at position j; and where the user verifies the reply.

3. A method of using claim 1, where the user sends (hash, i, j) and asks the bank to reply with the hash made from position j.

4. A method of using claim 1, where the user hashes some combination of a web page that is to be sent to the bank, along with her mobile password, and adds this hash to the page, before transmission; and where the bank extracts the hash and verifies it against the page and mobile password, to ensure that the page was unchanged in transmission.

5. A method of using claim 4, where the roles of the user and bank are interchanged.

6. A method of using claim 2, where the “bank” is now another website (“anonymizer”), and where if the user and anonymizer successfully verify, then the mobile password is used to establish a direct encrypted channel; from which the user logs in to other websites using this channel and the anonymizer.

7. A method of a website (“Broker”) publishing a list of other companies that issue two factor gadgets (Two Factor List or TFL), whose passwords it is willing to recognise.

8. A method of using claim 7, where the Broker publishes its TFL to an Aggregator (“Agg”), which makes it available to its plug-ins.

9. A method of using claim 8, where a user with an account at the Broker and at a bank in the TFL obtains a token from the bank, after logging into the bank using a two factor gadget; she then submits the token and other ancillary data to the Broker, who can verify the token with the bank.

10. A method of using claim 9, where the user pre-establishes a common set of data with the Broker and bank, to enhance the security of the validation.
